(19) United States
(12) Patent Application Publication
(10) Pub. No.: US 2007/0087739 A1
(43) Pub. Date: Apr. 19, 2007

(54) Wireless local loop base station controller and a method for performing call processing using the same

(75) Inventor: Hyun Ju Jung, Anyang-si (KR)

Correspondence Address: FLESHNER & KIM, LLP, P.O. BOX 221200, CHANTILLY, VA, 20153, US

(73) Assignee: LG-Nortel Co., Ltd.

(21) Appl. No.: 11/546,995

(22) Filed: Oct. 13, 2006

(30) Foreign Application Priority Data
Oct. 17, 2005 (KR) 97334/2005

(51) Int. Cl. H04Q 7/20

(52) U.S. Cl. 455/422.1

(57) ABSTRACT

A wireless local loop (WLL) base station controller includes a call control processor adapted to perform call control according to an internetworking operation system (IOS) protocol and to manage information generated during call processing. The WLL controller further includes a common channel signaling processor adapted to process and manage messages interchanged according to the IOS protocol between the call control processor and mobile switching center. Also included is an operation control processor adapted to perform inter-process communication with a common channel signaling processor to bypass an IOS-related message delivered from the call control processor to the mobile switching controller. The WLL controller can therefore be reconstructed to serve as a base station controller of a 3G mobile communication network for converting a currently working WLL network into a 3G mobile communication network.

### BACKGROUND

1. Field

One or more embodiments described herein relate to processing calls in a mobile communication network.

2. Background

A WLL (Wireless Local Loop) uses a wireless communications link for providing plain old telephone service (POTS) and broadband Internet to consumers. A WLL is beneficial because it provides subscribers with the same quality service for wireless communication compared with wired communication, the latter of which is the conventional interface between a PSTN (Public Switched Telephone Network) exchange and subscribers.

A WLL of a CDMA (Code-Division Multiple Access) type provides a wireless interface. This type of WLL provides a system developed based on CDMA technology, which has an extraordinarily large capacity for subscribers, and the cellular technology. Since a CDMA-type WLL is based on a stationary service, it is advantageous in that numerous constraints and transmission loss in free space are substantially mitigated compared to those of a mobile telephone system. It is also advantageous because it can increase data transmission rate compared to other systems due to fading-free operations.

The network elements for a CDMA-type WLL include a BSC (Base Station Controller), a BTS (Base Station Transceiver), an FSU (Fixed Subscriber Unit), BSM (Base Station Manager), etc. The network elements may further include n IWF (InterWorking Function) for implementing data service.

Among the aforementioned network elements of the CDMA-type WLL, the BSC is based on CDMA technology, which can provide a high-capacity and high-quality service. The BSC can provide both analog-type overlap call service and cellular-type enblock call service. The BSC provides data service through a wireless interface, and may further provide additional services (e.g., CF (Call Forwarding), CW (Call Waiting), 3-way call, etc.), a PSTN interface, limited mobility and the like, which are provided by wired/wireless networks.

However, a traditional CDMA-type WLL is initially designed based on a fixed service for a wired telephone network and changing the subscriber interface into wired communication. Accordingly, a CDMA-type WLL is designed with very little consideration for mobility. Moreover, the WLL excludes the elements of a HLR (Home Location Register) and a VLR (Visitor Location Register), both of which are traditionally essential network components required for a mobile telephone service. Therefore, the mobility provided by the aforementioned type of WLL is limited to intra-BTS and inter-BTS.

Furthermore, traditional WLLs cannot provide additional services such as SMS (Short Message Service), VMS (Voice Message Service), wireless internet and the like, which are provided by the IN (Intelligent Network) of a mobile communication network configured to interface with IS-41 MAP (Mobile Application Part) protocol.

Notwithstanding these drawbacks, the mobile communication networks, which employ the use of a mobile communication technology such as CDMA, GSM (Global System for Mobile communication) or the like, is rapidly evolving. Thus, as mobile telephone service becomes more popular, there is inevitably higher market demand for mobility and additional services in mobile communications.

Accordingly, in the conventional WLL, a scheme has been considered in which physical interfaces are connected between BSCs to provide inter-BSC of limited mobility, and in which SMSC (Short Message Service Center) is directly interfaced therewith. However, such a scheme is disadvantageous since it is characterized by a number of system limitations or unattainable features for the WLL, which is based on the concept and services of wired telephone network.

### BRIEF DESCRIPTION OF THE DRAWINGS

The embodiments will be described in detail with reference to the following drawings in which like reference numerals refer to like elements, wherein:

FIG. 1 shows an embodiment of an R2/No.7 WLL BSC capable of interfacing with a 3G mobile communication network;

FIG. 2 shows an embodiment of a V5.2 WLL BSC capable of interfacing with a 3G mobile communication network;

FIG. 3 is a flowchart illustrating steps included in one embodiment of a method for implementing originating-call processing of a 3G mobile communication network using a WLL BSC, which is capable of interfacing with a 3G mobile communication network; and

FIG. 4 is a flowchart illustrating steps included in one embodiment of a method for implementing terminating-call processing of a 3G mobile communication network using a WLL BSC, which is capable of interfacing with a 3G mobile communication network.

### DETAILED DESCRIPTION

A base station controller (BSC), which is one of the network components of a CDMA-type WLL, can be classified into an R2/No.7 WLL BSC and a V5.2 WLL BSC depending on its interface type.

An R2/No.7 WLL BSC is an LE Local Exchange) which may have its own switch functionality, and which may be connected to a remote station via R2 signaling or CCS (Common Control Signaling). An R2/No.7 WLL BSC provides a variety of services for subscribers such as remote station interface, CW (Call Waiting), CF (Call Forwarding) and the like.

A V5.2 WLL BSC does not directly interface with a PSTN and provides the function of an access network which provides service through an LE. Because of these differences, the two types of WLL BSCs may have different resources and structures. Further, in order to implement an IOS V4.1 separate-type BSC capable of interfacing with a 3G mobile communication network based on the resources of the aforementioned types of WLL BSCs, the following developments may be implemented.

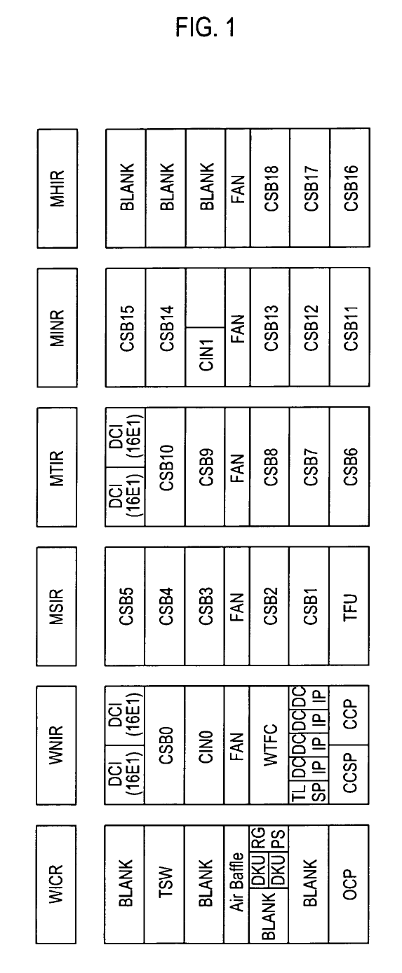

First, as illustrated in FIG. 1, an R2/No.7 WLL BSC capable of interfacing with a 3G mobile communication network in accordance with one embodiment described herein may include a CCP (Call Control Processor), a CSB (CDMA Selector Bank), a CIN (CDMA InterNetwork), a WTFC (WLL Timing & Frequency Control), a CCSP (Common Channel Signaling Processor), a TSW (Time Switch), a TSP (Time Switch Processor)/DCIP (Digital CEPT Interface Processor), an OCP (Operation Control Processor), a DCI (Digital CEPT Interface), a DKU (Disk Unit), a RGPS (Redundant Global Positioning System) and the like.

In the above configuration, the CCP is a main processor accommodated in the WLL BSC. The CCP may perform call control functionality such as setup and teardown requests of a call originated from a terminal or a PCX (Personal Communications eXchange), paging functionality, functionality of selector assignment and teardown, etc. according to the IOS v4.1 protocol so as to interface with the 3G mobile communication network. The CCP may also manage information generated during call processing, including, for example, call status information of each selector, traffic channel address, selector address, assignment information, cell ID (identifier) information and the like.

The CSB in the WLL BSC may perform mutual conversion between QCELF (QualComm Code Excited Linear Predictive Coding) voice data of a BTS channel card and PCM (Pulse Code Modulation) data of a time switch in an exchange.

The CIN may provide a communication path of voice packets and control packets in a mobile communication system employing a CDMA method. The CIN may also provide a connection path to an IPC (Inter-Process Communication) node in the exchange. As such, in accordance with the present embodiment the CIN may optionally provide every physical connection path required for call processing of a mobile subscriber.

The WTFC includes a timing module that uses TOD (Time Of Day) information and a synchronization signal, which are provided from an RGPS receiver, to provide synchronization and clocks for the system. The WTFC may also include a module adapted to perform error detection for the BTS hardware and system environments.

The CCSP is a hardware unit that preferably includes two pseudo VME (VERSA Module Eurocard) buses to process signal messages and to interface with a G-bus that is an upper communication bus in the MTP (Message Transfer Part) level-3 functionality of the SS (Signal System) No.7, as well as to interface with a ST (Specification Translation) block of the level-2 functionality. The CCSP may communicate with 16 signal links (at maximum) through VME buses and interfaces with the time switch through a sub highway.

The CCSP may further process and manage the messages interchanged according to the IOS v4.1 protocol between the CCP and a MSC (Mobile Switching Center). The CCSP may also specify the procedures for software blocks and messages interchanged between the blocks. This is so that the SCCP (Signaling Connection Control Part) supports a connection-oriented procedure service and a connectionless procedure service, which ensures support for the IOS v4.1 functionality.

The IOS messages destined for the MSC are packed in No.7 messages to be delivered to the MSC. When a SI (Service Indicator) of a message indicates the SCCP, the message is delivered to the SCCP. Further, when a SSN (SubSystem Number) of the delivered message is 252 (0xFC), it is transmitted to a BSAP (Base Station Application Part) where the IOS message is processed. For the IOS message transmitted from the BSAP to the MSC, it is first checked whether the messages are normal. When the message is normal, No.7 routing information is inserted into the message, which is then transmitted to the MSC via the MTP

Here, the routing indicator of the IOS v4.1-related message should be “Route on SSN.” If not, in case of a UDT message (N-UNITDATA), an N-NOTICE identifier message is transmitted to a user part or a UDTS message is sent to a base station according to the return option. Also, in case of a CR message for connection setup, an N-DISCONNECT identifier message is transmitted to a user part or a CREF (Connection Refusal) message is sent to a base station.

As described above, the SCCP may provide a connection-oriented procedure service and a connectionless procedure service to support IOS v4.1 functionality. In the connection-oriented procedure service, only a service rank Class 2 of the IOS is available. In the connection-oriented procedure service, when an N-connection request message (N-CONNECT request) is received from a user part to access the base station, a CR (Connection Request) message is transmitted to an MTP. Further, when a CC (Connection Confirm) message is received from the base station, connection resources are assigned and an N-connection confirmation message is then transmitted to a user part.

On the other hand, in the connectionless procedure service, only a service rank Class 0 is available. In the connectionless procedure service, when an N-UNITDATA is received from a user part, an N-NOTICE identification message is transmitted to the user part. Further, if a base station is in the available status, a SLS (Signaling Link Selector) is randomly selected and a message is transmitted through the MTP. Further, when a UDT message is received from a base station, an N-UNITDATA identification message is transmitted to the user part.

The aforementioned CCP and CCSP may have different operating systems, which make IPC impossible. In such a case, the IOS v4.1 messages may be interchanged via the OCP.

The TSW may perform time slot switching to provide a channel path. The TSW interfaces with a trunk line through a SHW (Sub HighWay) in order to interchange voice, data and inter-station signals with other exchanges. The TSP controls a time switch and a local service interface unit The DCIP controls a digital trunk for transit calls.

The OCP bypasses IOS v4.1-related messages to the MSC through an IOS v4.1 interface to operate the WLL BSC as a separate-type BSC. For this purpose, the CCSP and the OCP communicates via IPC, and the OCP distinguishes between messages destined for the CCSP and messages transmitted from the CCSP, to bypass the messages to the appropriate counterpart processors.

Further, the OCP detects the status of circuit resources. An IOC v4.1 processing unit of the OCP packs the messages of a circuit resource part specified in the IOS v4.1, including block, unblock, global reset and the like. The OCP commands the CCP to block, unblock and the like.

The DCI is a unit for incorporating primary-group transmission lines (E1:2.048 Mbps) of CEPT (Conference of European Posts and Telecommunications) for connection with a base station. It interfaces the channels between 16 SHWs connected to TSWs and 16 E1 transmission lines, and processes inter-station signals generated in each of the channels. It also provides reference clocks synchronized with a higher-level exchange.

The DKU is used for data loading of a switch part. The RGPS receives time and location information from a GPS satellite, and controls a high definition OCXO (Oven-controlled Crystal Reference Oscillator) therein to provide clocks synchronized to a UTC (Universal Time Coordinated).

As discussed above, the shape of the R2/No.7 WLL BSC in accordance with one embodiment may be similar to that of a conventional R2/No.7 WLL BSC. However, in terms of functionality, the R2/No.7 WLL BSC may function as a separate-type BSC that supports IOS v4.1 functionality. Since the R2/No.7 WLL BSC can use a time switch structure of a WLL BSC as is, this embodiment may allow the simultaneous implementation of the IOS v4.1 protocol and the time switch processing.

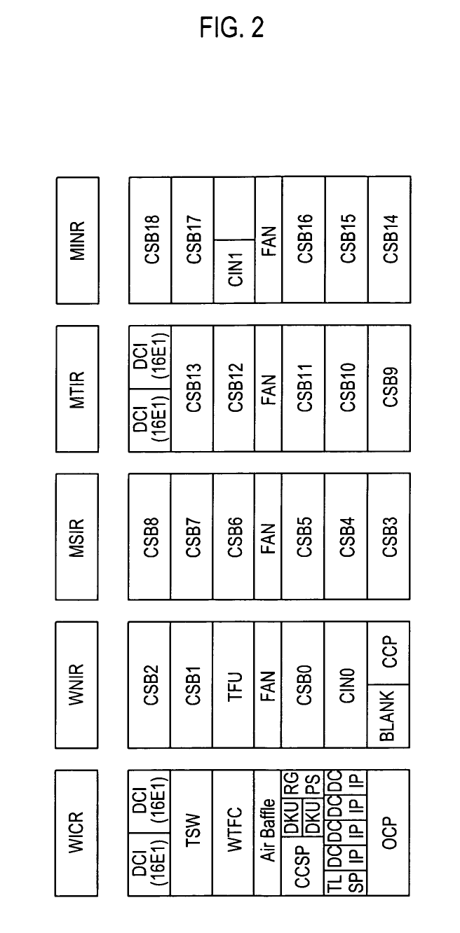

In accordance with another embodiment, a V5.2 WLL BSC capable of interfacing with a 3G mobile communication network may include CCP, CSB, CIN, WTFC, TSW, TLSP, DCIP, OCP, DCI, DKU, RGPS and the like, as shown in FIG. 2. The V5.2 WLL BSC may further include CCSP in addition to a conventional V5.2 WLL BSC.

In such a configuration, the structures and operations of the CCP, CSB, CIN, WTFC, TSW, TLSP, DCIP, OCP, DCI, DKU, RGPS and CCSP may be similar to those of an R2/No.7 WLL BSC. Therefore, they will not be described herein in detail.

A VCP (V5.2 Control Processor) may be included in the WLL BSC to provide layer-2 and layer-3 of a V5.2 AN (Auto Negotiation) protocol, as well as a V5.2 AN manager. Further, the VCP may provide a connection path to an IPC node in an exchange, which provides a path required for processing a subscriber's call.

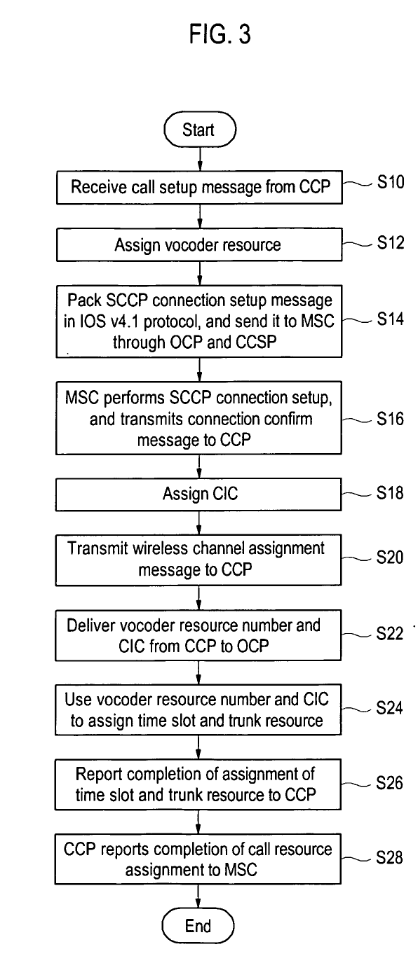

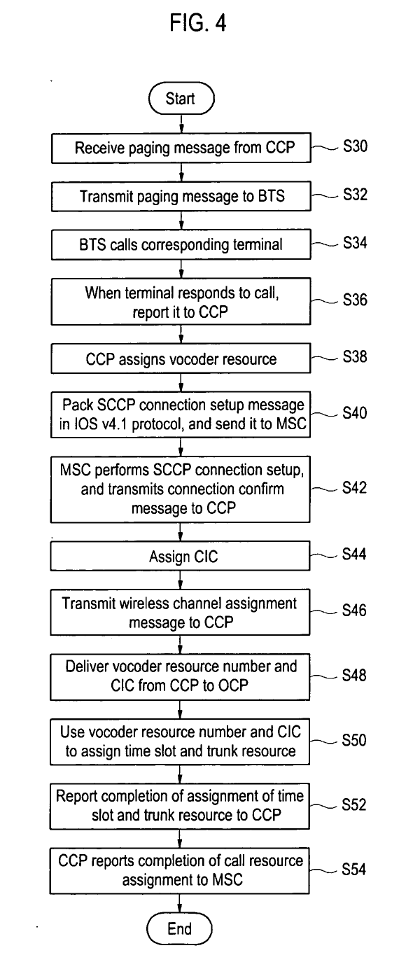

FIGS. 3 and 4 are flowcharts showing steps included in various embodiments of a method for implementing call processing of a 3G mobile communication network using a WLL BSC, which is capable of interfacing with a 3G mobile communication network. First, it should be noted that in order for a WLL BSC to interface with a 3G mobile communication network, the WLL BSC should be able to perform call processing and circuit resource management according to a 3G-based IOS v4.1 protocol. The support for the IOS v4.1 protocol may be performed in a related software block of a CCP.

FIG. 3 specifically shows steps included in one embodiment of a process of implementing originating-call processing. When a user of a 3G mobile terminal inputs a destination number and presses a call button to request an originating call, the mobile terminal transmits an originating-call message to a BTS. In response to receiving the originating-call message from the mobile terminal, the BTS assigns a frame offset and then transmits an originating-call setup message MobOrg₁₃ B2C, which includes the frame offset value, to a CCP of a WLL BSC.

When the CCP of the WLL BSC receives the originating-call setup message MobOrg₁₃ B2C transmitted from the BTS of the 3G mobile communication network (S10), the CCP of the WLL BSC uses the frame offset information included in the originating-call setup message MobOrg_B2C to assign an available vocoder resource (particularly, a vocoder selector ID) (S12). Thereafter, the CCP of the WLL BSC performs an SCCP connection setup operation for communication with an MSC. That is, the CCP packs an SCCP connection setup message SCCPConnReq, which requests for an SCCP connection for communication with the MSC, in the IOS v4.1 protocol, and then transmits the packed message to the MSC through an OCP and a CCSP (S14).

In response to receiving the SCCP connection request message SCCPConnReq packed in the IOS v4.1 protocol from the CCP through the OCP and the CCSP in the step S14, the MSC performs an SCCP connection setup according to the IOS v4.1 protocol and then transmits a connection confirm message CC (Connection Confirm) to the CCP as a response to the SCCP connection request message (S16). Thereafter, the MSC assigns an available CIC (Circuit ID Code) (S18) and transmits a wireless channel resource assignment request message AssignRequest, which includes the assigned CIC information, to the CCP (S20).

In response to receiving the wireless channel resource assignment request message AssignRequest transmitted from the MSC in the step S20, the CCP transmits the vocoder resource number, which the CCP assigned in the step S12, and the CIC included in the wireless channel resource assignment request message to an OCP of a WLL BSC (S22). In response to receiving the vocoder resource number and the CIC from the CCP, the OCP uses the vocoder resource number and the CIC to complete assigning a time slot and a trunk resource for a call setup (S24). It then reports to the CCP that the assignment of the time slot and the trunk resource is completed (S26). In response to receiving the report that the assignment of the time slot and the trunk resource has been completed from the OCP in the step S26, the CCP transmits an assignment completion message AssignCmpl to the MSC according to the IOS v4.1 protocol in order to report the completion of the call resource assignment (S28).

Further, if the MSC, which received the SCCP connection request message SCCPConnReq packed in the IOS v4.1 protocol from the CCP through the OCP and the CCSP in the step S14, fails to perform the SCCP connection setup, then it transmits a connection refusal message CREF (Connection Refusal) to the CCP as a response to the SCCP connection request message. In response to receiving the connection refusal message CREF from the MSC, the CCP returns the resources occupied for a call setup, such as src_ref_no, and migrates to an idle status.

FIG. 4 shows steps included in one embodiment of a process of implementing terminating-call processing. When a CCP of a WLL BSC receives a paging message PagingReq transmitted from an MSC (S30), the CCP generates a paging_task to reconstruct the paging message PagingReq received from the MSC. It then transmits the reconstructed paging message PaingReq to a BTS (S32). In response to receiving the paging message PagingReq from the CCP, the BTS calls a corresponding mobile terminal according to the received paging message PagingReq (S34). When the corresponding mobile terminal responds to the mobile terminal call, the BTS transmits a paging response message PagingRsp to the CCP to report that the corresponding mobile terminal responded to the call (S36).

In response to receiving the paging response message PagingRsp from the BTS in the step S36, the CCP uses information of a frame offset assigned by the BTS to assign an available vocoder resource (vocoder selector ID) (S38). Then, the CCP packs an SCCP connection request message SCCPConnReq, which requests for an SCCP connection, in the IOS v4.1 protocol. It then transmits the packed message to an MSC through an OCP and a CCSP (S40).

In response to receiving the SCCP connection request message SCCPConnReq packed in the IOS v4.1 protocol from the CCP through the OCP and the CCSP in the step S40, the MSC performs an SCCP connection setup according to the IOS v4.1 protocol and then transmits a connection confirm message CC (Connection Confirm) to the CCP as a response to the SCCP connection request message (S42). Thereafter, the MSC assigns an available CIC (Circuit ID Code) (S44) and transmits a wireless channel resource assignment request message AssignRequest, which includes the assigned CIC information, to the CCP (S46).

In response to receiving the wireless channel resource assignment request message AssignRequest transmitted from the MSC in the step S46, the CCP transmits the vocoder resource number, which was assigned in the step S38, and the CIC included in the wireless channel resource assignment request message to an OCP of a WLL BSC (S50). In response to receiving the vocoder resource number and the CIC from the CCP, the OCP uses the vocoder resource number and the CIC to complete assigning a time slot and a trunk resource for a call setup (S52). It then reports to the CCP that the assignment of the time slot and the trunk resource is completed (S54). In response to receiving the report that the assignment of the time slot and the trunk resource has been completed from the OCP in the step S54, the CCP transmits an assignment completion message AssignCmpl to the MSC according to the IOS v4.1 protocol to report the completion of the call resource assignment (S56).

Further, if the MSC, which received the SCCP connection request message SCCPConnReq packed in the IOS v4.1 protocol from the CCP through the OCP and the CCSP in the step S40, fails to perform the SCCP connection setup, then it transmits a connection refusal message CREF (Connection Refusal) to the CCP as a response to the SCCP connection request message. In response to receiving the connection refusal message CREF from the MSC, the CCP returns the resources occupied for a call setup, such as src_ref_no, and migrates to an idle status.

In accordance with a WLL BSC capable of interfacing with a 3G mobile communication network and a method for implementing call processing of a 3G mobile communication network using the same as described above, a WLL BSC can be reconstructed to serve as a BSC of a 3G mobile communication network for the purpose of converting a currently working WLL network into a 3G mobile communication network.

A WLL BSC adapted to interface with a 3G mobile communication network and a method for implementing call processing of a 3G mobile communication network using the same may therefore be implemented to perform call processing at the WLL BSC according to a 3G-based IOS (Internetworking Operating System) v4.1 protocol. As such, the embodiments described herein may allow the call processing of a 3G mobile communication network while using a time switch, E1, call-processing processor resources and the like of the WLL BSC.

According to one particular embodiment, a wireless local loop base station controller comprises: a CCP (Call Control Processor) adapted to perform call control according to an IOS (Internetworking Operation System) protocol, as well as to manage information generated in call processing; a CCSP (Common Channel Signaling Processor) adapted to process and manage messages interchanged according to the IOS protocol between the CCP and an MSC (Mobile Switching Center); and an OCP (Operation Control Processor) between the CCP and the CCSP, which is adapted to perform an IPC (Inter-Process Communication) communication with the CCSP to bypass an IOS-related message delivered from the CCP to the MSC.

In accordance with another embodiment, a method for implementing originating-call processing of a mobile communication network using a wireless local loop base station controller comprises the following steps: receiving an originating-call setup message transmitted from a base station transceiver; assigning a vocoder resource in response to receiving the originating-call setup message; transmitting an SCCP (Signaling Connection Control Part) connection request to a MSC (Mobile Switching Center) according to an IOS (Internetworking Operating System) protocol; receiving a message including a CIC (Circuit ID Code) from the MSC; using the vocoder resource number and the CIC to assign wireless channel resources in response to receiving the message including the CIC; and reporting a completion of call resource assignment to the MSC according to the IOS protocol.

In accordance with another embodiment, a wireless local loop base station controller may be adapted to process an originating call of a mobile communication network according to the aforementioned method for implementing originating-call processing of a mobile communication network using a wireless local loop base station controller.

In accordance with another embodiment, a method for implementing terminating-call processing of a mobile communication network using a wireless local loop base station controller comprises the following steps: receiving a paging message transmitted from a MSC (Mobile Switching Center) of a mobile communication network; reconstructing the paging message and transmitting the reconstructed paging message to a base station transceiver; receiving a paging response message from the base station transceiver; assigning an available vocoder resource in response to receiving the paging response message; transmitting a SCCP (Signaling Connection Control Part) connection request to the MSC according to an IOS (Internetworking Operating System) protocol; receiving a message including a CIC (Circuit ID Code) from the MSC; using the vocoder resource number and the CIC to assign wireless channel resources in response to receiving the message including the CIC; and reporting a completion of call resource assignment to the MSC according to the IOS protocol.

In accordance with another embodiment, a wireless local loop base station controller may be adapted to process a terminating call of a mobile communication network according to the aforementioned method for implementing terminating-call processing of a mobile communication network using a wireless local loop base station controller.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments of the present invention have been described with reference to a number of illustrative embodiments thereof, it should be understood that numerous other modifications and embodiments can be devised by those skilled in the art that will fall within the spirit and scope of the principles of this invention. More particularly, reasonable variations and modifications are possible in the component parts and/or arrangements of the subject combination arrangement within the scope of the foregoing disclosure, the drawings and the appended claims without departing from the spirit of the invention. In addition to variations and modifications in the component parts and/or arrangements, alternative uses will also be apparent to those skilled in the art.

What is claimed is:

1. A wireless local loop base station controller, comprising:
a CCP (Call Control Processor) to perform call control based on an IOS (Internetworking Operation System) protocol and to manage information generated during call processing;
a CCSP (Common Channel Signaling Processor) to process and manage messages interchanged according to the IOS protocol between the CCP and an MSC (Mobile Switching Center); and
an OCP (Operation Control Processor) located between the CCP and the CCSP, to perform an IPC (Inter-Process Communication) communication with the CCSP to bypass an IOS-related message delivered from the CCP to the MSC.

2. The base station controller of claim 1, wherein the CCP cooperates with the OCP to assign a time switch in the base station controller when performing call processing according to the IOS protocol.

3. The base station controller of claim 1, wherein the CCP manages at least one of call status information, traffic channel address information, selector address information, assignment information, or cell identifier information.

4. The base station controller of claim 1, wherein the OCP bypasses the IOS-related message through an IOS interface to allow the base station controller to operate as a separate-type BSC.

5. The base station controller of claim 1, wherein the OCP bypasses the IOS-related message by distinguishing between messages destined for the CCSP and messages transmitted from the CCSP.

6. A method for implementing originating-call processing in a mobile communication network using a wireless local loop base station controller, comprising:
receiving an originating-call setup message transmitted from a base station transceiver;
assigning a vocoder resource in response to receiving the originating-call setup message;
transmitting an SCCP (Signaling Connection Control Part) connection request to an MSC (Mobile Switching Center) according to an IOS (Internetworking Operating System) protocol;
receiving a message including a CIC (Circuit ID Code) from the MSC;
using the vocoder resource number and the CIC to assign wireless channel resources in response to receiving the message including the CIC; and
reporting completion of call resource assignment to the MSC according to the IOS protocol.

7. The method of claim 6, wherein transmitting the SCCP connection request includes:
packing an SCCP connection request message according to the IOS protocol at a CCP (Call Control Processor) of the wireless local loop base station controller; and
transmitting the packed message to the MSC through an OCP (Operation Control Processor) and a CCSP (Common Channel Signaling Processor).

8. The method of claim 7, wherein the message including the CIC is a wireless channel resource assignment request message and wherein assigning the wireless channel resources includes:
transmitting the vocoder resource number and the CIC from the CCP to the OCP; and
assigning the wireless channel resources at the OCP based on the vocoder resource number and the CIC.

9. The method of claim 8, wherein the wireless channel resources include a time slot and a trunk resource for a call setup.

10. The method of claim 7, further comprising:
if a connection refusal message is received from the MSC that received the SCCP connection request message, then returning resources occupied for a call setup and migrating to an idle status at the CCP.

11. A wireless local loop base station controller configured to process an originating call of a mobile communication network based on the method of claim 6.

12. A method for implementing terminating-call processing of a mobile communication network using a wireless local loop base station controller, comprising:
receiving a paging message transmitted from an MSC (Mobile Switching Center) of a mobile communication network;
reconstructing the paging message and transmitting the reconstructed paging message to a base station transceiver;
receiving a paging response message from the base station transceiver;
assigning an available vocoder resource in response to receiving the paging response message;
transmitting an SCCP (Signaling Connection Control Part) connection request to the MSC according to an IOS (Internetworking Operating System) protocol;
receiving a message including a CIC (Circuit ID Code) from the MSC;
using the vocoder resource number and the CIC to assign wireless channel resources in response to receiving the message including the CIC; and
reporting completion of call resource assignment to the MSC according to the IOS protocol.

13. The method of claim 12, wherein the operation of transmitting the SCCP connection request includes:
packing an SCCP connection request message according to the IOS protocol at a CCP (Call Control Processor) of the wireless local loop base station controller; and
transmitting the packed message to the MSC through an OCP (Operation Control Processor) and a CCSP (Common Channel Signaling Processor).

14. The method of claim 13, wherein the message including the CIC is a wireless channel resource assignment request message and wherein assigning the wireless channel resources includes:
transmitting the vocoder resource number and the CIC from the CCP to the OCP; and
assigning the wireless channel resources at the OCP based on the vocoder resource number and the CIC.

15. The method of claim 14, wherein the wireless channel resources include a time slot and a trunk resource for a call setup.

16. The method of claim 13, further comprising:
if a connection refusal message is received from the MSC that received the SCCP connection request message, then returning resources occupied for a call setup and migrating to an idle status at the CCP.

17. A wireless local loop base station controller configured to process a terminating call of a mobile communication network based on the method of claim 12.
